(19) United States
(12) Patent Application Publication
(10) Pub. No.: US 2023/0316715 A1
(43) Pub. Date: Oct. 5, 2023

(54) Identifying Unseen Objects From Shared Attributes Of Labeled Data Using Weak Supervision

(71) Applicant: Ridecell, Inc., San Francisco, CA (US)

(72) Inventors: Arun Kumar Chockalingam Santha Kumar, Milpitas, CA (US); Paridhi Singh, San Jose, CA (US); Gaurav Singh, San Jose, CA (US)

(21) Appl. No.: 18/118,616

(22) Filed: Mar. 7, 2023

Related U.S. Application Data
(60) Provisional application No. 63/317,420, filed on Mar. 7, 2022.
(60) Provisional application No. 63/414,337, filed on Oct. 7, 2022.
(60) Provisional application No. 63/426,248, filed on Nov. 17, 2022.

(51) Int. Cl. G06V 10/764; G06V 10/762; G06V 10/82

(52) U.S. Cl. CPC G06V 10/764; G06V 10/763; G06V 10/82

(57) ABSTRACT

Systems and methods for categorizing an object captured in an image are disclosed. An example method includes providing a neural network configured to receive the image and to provide a corresponding output. The method additionally includes defining a plurality of known object classes, each corresponding to a real-world object class and being defined by a class-specific subset of visual features identified by the neural network. The method includes acquiring a first two-dimensional (2-D) image including a first object and providing the first 2-D image to the neural network. The neural network identifies a particular subset of the visual features corresponding to the first object in the first 2-D image. The method also includes identifying a first known object class most likely to include the first object, and identifying a second known object class that is next likeliest to include the first object.

### RELATED APPLICATIONS

This application claims the benefit of priority to U.S. Provisional Patent Application No. 63/317,420 filed on Mar. 7, 2022 by at least one common inventor and entitled “Identifying Unseen Objects from Shared Attributes of Labeled Data Using Weak Supervision”, and also claims the benefit of priority to U.S. Provisional Patent Application No. 63/414,337 filed on Oct. 7, 2022 by at least one common inventor and entitled “Reasoning Novel Objects Using Known Objects”, and also claims the benefit of priority to U.S. Provisional Patent Application No. 63/426,248 filed on Nov. 17, 2022 by at least one common inventor and entitled “System And Method For Identifying Objects”, all of which are incorporated herein by reference in their respective entireties.

### BACKGROUND OF THE INVENTION

### Field of the Invention

This invention relates generally to machine learning, and more particularly to image classification applications of machine learning.

### Description of the Background Art

Detecting unseen objects (i.e. objects that were not used to train a neural network) has been an enormous challenge and a problem of significant relevance in the field of computer vision, especially in detecting rare objects. The implications of solving this problem are not just limited to real time perception modules, but also for offline or off-board perception applications such as automated tagging, data curation, etc. Based on just a few instances, humans can identify roughly 30k object classes and dynamically learn more. It is an enormous challenge for a machine to identify so many object classes. It is even more of a challenge to gather and label the data required to train models to learn and classify objects.

Zero-shot learning aims to accomplish detection of unseen objects from classes that the network has not been trained on. The goal is to establish a semantic relationship between a set of labeled data from known classes to the test data from unknown classes. The network is provided with the set of labeled data with known classes and, using a common semantic embedding, tries to identify objects from unlabeled classes.

Mapping the appearance space to a semantic space allows for semantic reasoning. However, challenges, such as semantic-visual inconsistency, exist where instances of the same attribute that are functionally similar are visually different. In addition, to train mapping between semantic to visual space requires large amounts of labeled data and textual descriptions.

The prior methods rely heavily on the use of semantic space. The semantic space is generally constructed/learned using a large, available text corpus (e.g. Wikipedia data). The assumption is that the “words” that co-occur in semantic space will reflect in “objects or attributes” co-occurring in the visual space.

For example, there are a few sentences in text corpora such as “Dogs must be kept on a leash while in the park”, “The dog is running chasing the car when the owner is trying to hold the leash”, etc. Given an image (and an object detector), if the object detector detects the objects “person” and “dog” from the image, the other plausible objects in the image could be “leash”, “car”, “park”, “toy” etc. The object detector is not explicitly trained to detect objects such as “leash” or “park”, but is able to guess them due to the availability of the semantic space. This method of identifying objects without having to train an object detector is called Zero Shot Learning. This method can be extended beyond objects, to attributes as well. For example: an attribute “tail” is common across most “animal” categories, or “wheel” for most “vehicles”. In other words, we not only know about objects that co-occur, but also features, attributes, or parts that make up an object. Thus, if an object has a “tail” and a “trunk”, it is probably an “elephant”.

While the semantic space is quite useful in identifying plausible objects or even some attributes, it cannot be generalized due to a number of reasons. First, humans often categorize parts of an object based on their functionality rather than their appearance. This reflects on our text corpus, and in turn creates a gap between features or attributes in semantic space and visual space. Second, semantic space does not emphasize most parts or features enough for those to be used for zero-shot learning. The semantic space relies on co-occurring words (e.g., millions of sentences with words co-occurring in them). Machine Learning algorithms (such as GPT3 or BERT) are able to learn and model semantic distance, but some attributes/parts, such as a “windshield” or a “tail light” of a “vehicle” object class do not get as much mention in textual space as a “wheel”. Therefore, there is an incomplete representation between attributes in semantic space with respect to attributes in visual space, and not all visually descriptive attributes are used when relying on semantic space.

In addition, while the semantic space can be trained with unlabeled openly available text corpora, the zero shot learning methods often need attribute annotations for known object classes. These annotations are difficult to procure.

The alternative to relying on semantic space is to use only visual space, which requires obtaining more sophisticated annotations for visual data. In other words, annotations (e.g. bounding boxes) that are not just object-level (e.g., cars, buses etc.), but also part-level (e.g., windshield, rearview mirror, etc.) are required. Such annotations remove the reliance on semantic space, but the cost of obtaining such fine grained levels of annotations is exorbitant.

A typical object classification network is trained as follows. First, a set of images containing objects and their known corresponding labels (such as “dog”, “cat”, etc.) is provided. Then, a neural network takes as input the image, and learns to predict its label. The predicted label is often a number like “2” or “7”. This number generally corresponds to a specific object class that can be decided or assigned randomly prior to training. In other words, “3” could mean “car” and “7” could mean “bike”. Next, the network predicts the label, say “7”, in a specific way called “one-hot encoding”. As an example, there are 10 object classes in total, instead of predicting “7” as a number directly, the model predicts [0, 0, 0, 0, 0, 0, 1, 0, 0, 0]. All numbers except for the 7th element are zero, which can also be interpreted as probabilities: the probability of an object belonging to each class is ‘0’, but is ‘1’ for class 7. The training is done using hundreds or thousands of images for each object instance, over a few epochs/iterations through the whole dataset, using the known object labels as ground truth. The loss function is the quantification of prediction error by the network against the ground truth. The loss trains the network (which has random weights at the beginning and predicts random values) to learn and predict object classes accurately toward the end of the training.

The example learning algorithm learns to predict the correct object, but due to the way it is trained, it is heavily penalized for misclassifications. In other words, if a classifier is trained to classify “truck” vs “car”, then the method not only gets rewarded for predicting the correct category, but it is also penalized for predicting the wrong category. The prior methods could be appropriate for a setting where there is enough data for each object class, when there is no need for zero shot learning. In reality, a “truck” and a “car” have a lot more in common than a “car” and a “cat”, and this similarity is not at all utilized in prior methods.

When the prior models encounter a new object or a rare object, the prior training strategies fail. There is no practical way to train the network for every rare category (e.g. a forklift) as much as it is trained for a common category (e.g. a car). It is not only challenging to procure images for rare objects, but also the number of classes would be far too many for a network/algorithm to learn and classify.

### SUMMARY

Due to some of the aforementioned shortcomings, a novel example method that does not rely on semantic space for reasoning attributes, but also does not require fine-grained annotations, is described. A novel example loss function that equips any vanilla object detection (deep learning) algorithms to reason objects as a combination of parts or visual attributes is also described.

Generalizing machine learning models to solve for unseen problems is one of the key challenges of machine learning. An example novel loss function utilizes weakly supervised training for object detection that enables the trained object detection networks to detect objects of unseen classes and also identify their super-class.

An example method uses knowledge of attributes learned from known object classes to detect unknown object classes. Most objects that we know of can be semantically categorized and clustered into super-classes. Object classes within the same semantic clusters, often share appearance cues (such as parts, colors, functionality, etc.) between them. The example method exploits the appearance similarities that exist between object classes within a super-class to detect objects that are unseen by the network without relying on semantic/textual space.

An example method leverages local appearance similarities between semantically similar classes for detecting instances of unseen classes.

An example method introduces an object detection technique that tackles aforementioned challenges by employing a novel loss function that exploits attribute similarities between object classes without using semantic reasoning from textual space.

Example methods for categorizing an object captured in an image are disclosed. An example method includes providing a neural network including a plurality of nodes organized into a plurality of layers. The neural network can be configured to receive the image and to provide a corresponding output. The example method additionally includes defining a plurality of known object classes. Each of the known object classes can correspond to a real-world object class and can be defined by a class-specific subset of visual features identified by the neural network. The example method additionally includes acquiring a first two-dimensional (2-D) image including a first object and providing the first 2-D image to the neural network. The neural network can be utilized to identify a particular subset of the visual features corresponding to the first object in the first 2-D image. The example method can additionally include identifying, based on the particular subset of the visual features, a first known object class most likely to include the first object, and identifying, based on the particular subset of the visual features, a second known object class that is next likeliest to include the first object.

A particular example method can further include determining, based on the first known object class and the second known object class, a superclass most likely to include the first object. The superclass can include the first known object class and the second known object class. The particular example method can further include segmenting the first 2-D image into a plurality of image segments. Each image segment can include a portion of the first 2-D image, and the step of providing the first 2-D image to the neural network can include providing the image segments to the neural network. The step of identifying the first known object class can include identifying, for each image segment of the plurality of image segments, an individual one of the known object classes most likely to include a portion of the object contained in a corresponding image segment of the plurality of image segments.

In the particular example method, the step of identifying the first known object class can include, for each object class of the known object classes, identifying a number of the image segments of the plurality of image segments that contain a portion of the object most likely to be included in the respective object class of the known object classes. The step of determining the superclass most likely to include the first object can include determining the superclass based at least in part on the number of the image segments that contain the portion of the object most likely to be included in the each object class of the known object classes.

In an example method, the step of segmenting the first 2-D image into the plurality of image segments can include segmenting the first 2-D image into the plurality of image segments. The plurality of image segments can each include exactly one pixel of the first 2-D image.

An example method can additionally include receiving, as an output from the neural network, an output tensor including a plurality of feature vectors. Each feature vector of the plurality of feature vectors can be indicative of probabilities that a corresponding segment of the first 2-D image corresponds to each object class. The example method can additionally include calculating an average of the feature vectors to generate a prediction vector indicative of the first known object class and the second known object class. The prediction vector can have a number of dimensions equal to a number of the known object classes.

A particular example method can additionally include providing a plurality of test images to the neural network. Each test image can include a test object. The particular example method can additionally include segmenting each of the plurality of test images to create a plurality of test segments, and embedding each test segment of the plurality of test segments in a feature space to create embedded segments. The feature space can be a vector space having a greater number of dimensions than the images. The particular example method can additionally include associating each of the embedded segments with a corresponding object class according to a test object class associated with a corresponding one of the test images. The particular example method can additionally include identifying clusters of the embedded segments in the feature space, and generating a cluster vector corresponding to an identified cluster. The cluster vector can be indicative of a subset of the known object classes associated with at least one of the embedded segments in the identified cluster.

The step of utilizing the neural network to identify the particular subset of the visual features corresponding to the first object in the first 2-D image can include embedding the segments of the first 2-D image in the feature space to generate a plurality of embedded segments of the first 2-D image. This step can also include identifying a nearest cluster to each of the embedded segments of the first 2-D image, and associating each of the embedded segments with a corresponding one of the cluster vectors. The corresponding cluster vector can be associated with the nearest cluster to the each of the embedded segments of the first 2-D image. The steps of identifying the first known object class and identifying the second known object class can include identifying the first known object class and the second known object class based at least in part on the corresponding cluster vector associated with each of the embedded segments of the first 2-D image.

Example systems for categorizing an object captured in an image are also disclosed. An example system includes at least one hardware processor and memory. The hardware processor(s) can be configured to execute code. The code can include a native set of instructions that cause the hardware processor(s) to perform a corresponding set of native operations when executed by the hardware processor(s). The memory can be electrically connected to store data and the code. The data and the code can include a neural network including a plurality of nodes organized into a plurality of layers. The neural network can be configured to receive the image and provide a corresponding output. The data and code can additionally include first, second, third, and fourth subsets of the set of native instructions. The first subset of the set of native instructions can be configured to define a plurality of known object classes. Each of the known object classes can correspond to a real-world object class, and can be defined by a class-specific subset of visual features identified by the neural network. The second subset of the set of native instructions can be configured to acquire a first two-dimensional (2-D) image including a first object and provide the first 2-D image to the neural network. The third subset of the set of native instructions can be configured to utilize the neural network to identify a particular subset of the visual features corresponding to the first object in the first 2-D image. The fourth subset of the set of native instructions can be configured to identify, based on the particular subset of the visual features, a first known object class most likely to include the first object. The fourth subset of the set of native instructions can also be configured to identify, based on the particular subset of the visual features, a second known object class that is next likeliest to include the first object.

In a particular example system, the fourth subset of the set of native instructions can be additionally configured to determine, based on the first known object class and the second known object class, a superclass most likely to include the first object. The superclass can include the first known object class and the second known object class. The second subset of the set of native instructions can be additionally configured to segment the first 2-D image into a plurality of image segments. Each image segment can include a portion of the first 2-D image. The second subset of the set of native instructions can also be configured to provide the image segments to the neural network. The fourth subset of the set of native instructions can be additionally configured to identify, for each image segment of the plurality of image segments, an individual one of the known object classes most likely to include a portion of the object contained in a corresponding image segment of the plurality of image segments. The fourth subset of the set of native instructions can additionally be configured to identify, for each object class of the known object classes, a number of the image segments of the plurality of image segments that contain a portion of the object most likely to be included in the each object class of the known object classes. The fourth subset of the set of native instructions can additionally be configured to determine the superclass based at least in part on the number of the image segments that contain the portion of the object most likely to be included in each object class of the known object classes.

In a particular example system, the plurality of image segments can each include exactly one pixel of the first 2-D image.

In a particular example system, the third subset of the set of native instructions can be additionally configured to receive, as an output from the neural network, an output tensor including a plurality of feature vectors. Each feature vector of the plurality of feature vectors can be indicative of probabilities that a corresponding segment of the first 2-D image corresponds to each object class. The fourth subset of the set of native instructions can be additionally configured to calculate an average of the feature vectors to generate a prediction vector indicative of the first known object class and the second known object class. The prediction vector can have a number of dimensions equal to a number of the known object classes.

In a particular example system, the data and the code can include a fifth subset of the set of native instructions. The fifth subset of the set of native instructions can be configured to provide a plurality of test images to the neural network. Each of the test images can include a test object. The fifth subset of the set of native instructions can additionally be configured to segment each of the plurality of test images to create a plurality of test segments. The neural network can be additionally configured to embed each test segment of the plurality of test segments in a feature space to create embedded segments. The feature space can be a vector space having a greater number of dimensions than the images.

The data and the code can also include a sixth subset of the set of native instructions. The sixth subset of the set of native instructions can be configured to associate each of the embedded segments with a corresponding object class according to a test object class associated with a corresponding one of the test images. The sixth subset of the set of native instructions can also be configured to identify clusters of the embedded segments in the feature space, and to generate a cluster vector corresponding to an identified cluster. The cluster vector can be indicative of a subset of the known object classes associated with at least one of the embedded segments in the identified cluster.

The neural network can be configured to embed the segments of the first 2-D image in the feature space to generate a plurality of embedded segments of the first 2-D image. The sixth subset of the set of native instructions can be additionally configured to identify a nearest cluster to each of the embedded segments of the first 2-D image and to associate each of the embedded segments with a corresponding one of the cluster vectors. The corresponding cluster vector can be associated with the nearest cluster to each of the embedded segments of the first 2-D image. The fourth subset of the set of native instructions can also be configured to identify the first known object class and the second known object class based at least in part on the corresponding cluster vector associated with each of the embedded segments of the first 2-D image.

### BRIEF DESCRIPTION OF THE DRAWINGS

The present invention is described with reference to the following drawings, wherein like reference numbers denote substantially similar elements:

FIG. 1 is a diagram showing a fleet of vehicles communicating with a remote data computing system;

FIG. 2 is a block diagram showing a server of FIG. 1 in greater detail;

FIG. 3A is a flow chart summarizing an example method, which can be implemented by an autonomous driving stack, which is utilized to pilot the vehicles of FIG. 1;

FIG. 3B is a block diagram showing an example autonomous driving stack;

FIG. 4 is a block diagram showing a first example use case for the object identifications generated by the classification model of FIG. 2;

FIG. 5 is a block diagram showing a second example use case for the object identifications generated by the classification model of FIG. 2;

FIG. 6 is a block diagram illustrating an example method for training a machine learning framework to classify objects;

FIG. 7A is a block diagram showing another example method for training a machine learning framework to classify objects;

FIG. 7B is a block diagram showing an example method for utilizing the trained machine learning framework of FIG. 7A to classify objects;

FIG. 8A is a graph showing an example feature space according to an example embodiment; and

FIG. 8B is a graph showing the example feature space of FIG. 8A including an additional set of embedded features.

### DETAILED DESCRIPTION

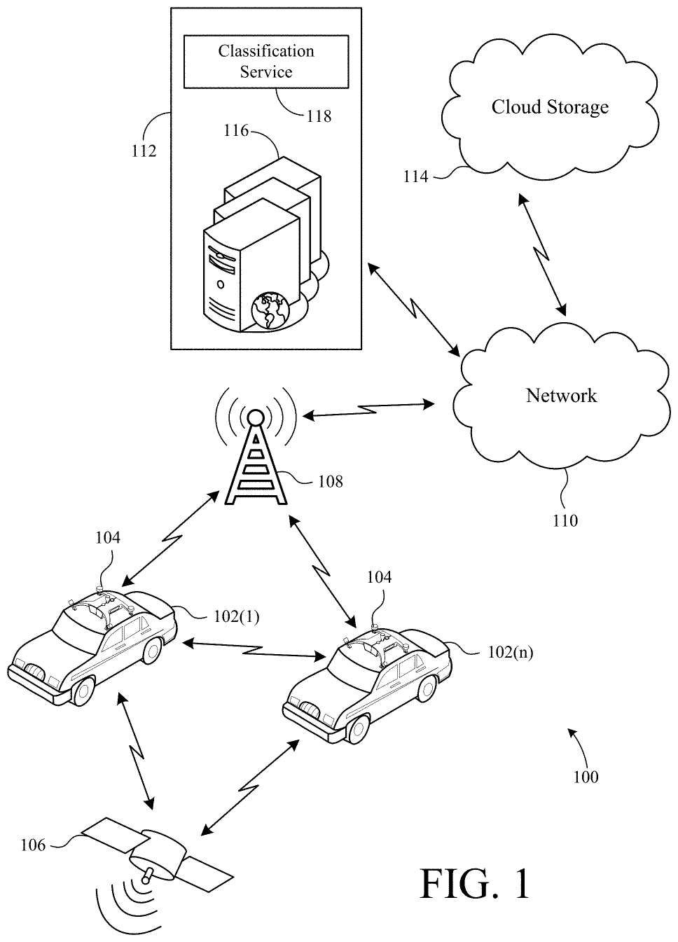

FIG. 1 shows an autonomous vehicle infrastructure 100, including a fleet of autonomous vehicles 102(1-n). In the example embodiment, the fleet of autonomous vehicles includes legacy vehicles (i.e., vehicles originally intended to be piloted by a human) that are outfitted with a detachable sensor unit 104 that includes a plurality of sensors (e.g., cameras, radar, lidar, etc.).

The sensors enable the legacy vehicle to be piloted in the same way as a contemporary autonomous vehicle, by generating and providing data indicative of the surroundings of the vehicle. More information regarding detachable sensor units can be found in U.S. patent application Ser. No. 16/830,755, filed on Mar. 26, 2020 by Anderson et al., which is incorporated herein by reference in its entirety. In alternate embodiments, vehicles 102(1-n) can include any vehicles outfitted with some kind of sensor (e.g., a dashcam) that is capable of capturing data indicative of the surroundings of the vehicle, whether or not the vehicles are capable of being piloted autonomously.

For the ease of operation, vehicles 102 should be able to identify their own locations. To that end, vehicles 102 receive signals from global positioning system (GPS) satellites 106, which provide vehicles 102 with timing signals that can be compared to determine the locations of vehicles 102. The location data is utilized, along with appropriate map data, by vehicles 102 to determine intended routes and to navigate along the routes. In addition, recorded GPS data can be utilized along with corresponding map data in order to identify roadway infrastructure, such as roads, highways, intersections, etc.

Vehicles 102 must also communicate with riders, administrators, technicians, etc. for positioning, monitoring, and/or maintenance purposes. To that end, vehicles 102 also communicate with a wireless communications tower 108 via, for example, a wireless cell modem (not shown) installed in vehicles 102 or sensor units 104. Vehicles 102 may communicate (via wireless communications tower 108) sensor data, location data, diagnostic data, etc. to relevant entities interconnected via a network 110 (e.g., the Internet). The relevant entities include, for example, a data center 112 and a cloud storage provider 114. Communications between vehicles 102 (and/or sensor units 104) and data center 112 may assist piloting, redirecting, and/or monitoring of autonomous vehicles 102. Cloud storage provider 114 provides storage for data generated by sensor units 104 and transmitted via network 110, the data being potentially useful.

Although vehicles 102 are described as legacy vehicles retrofitted with autonomous piloting technology, it should be understood that vehicles 102 can be originally manufactured autonomous vehicles, vehicles equipped with advanced driver-assistance systems (ADAS), vehicles outfitted with dashcams or other systems/sensors, and so on. The data received from vehicles 102 can be any data collected by vehicles 102 and utilized for any purpose (e.g., park assist, lane assist, auto start/stop, etc.).

Data center 112 includes one or more servers 116 utilized for communicating with vehicles 102. Servers 116 also include at least one classification service 118. Classification service 118 identifies and classifies objects captured in the large amount of data (e.g. images) received from vehicles 102 and/or sensor units 104. These classifications can be used for a number of purposes including, but not limited to, actuarial calculation, machine learning research, autonomous vehicle simulations, etc. More detail about the classification process is provided below.

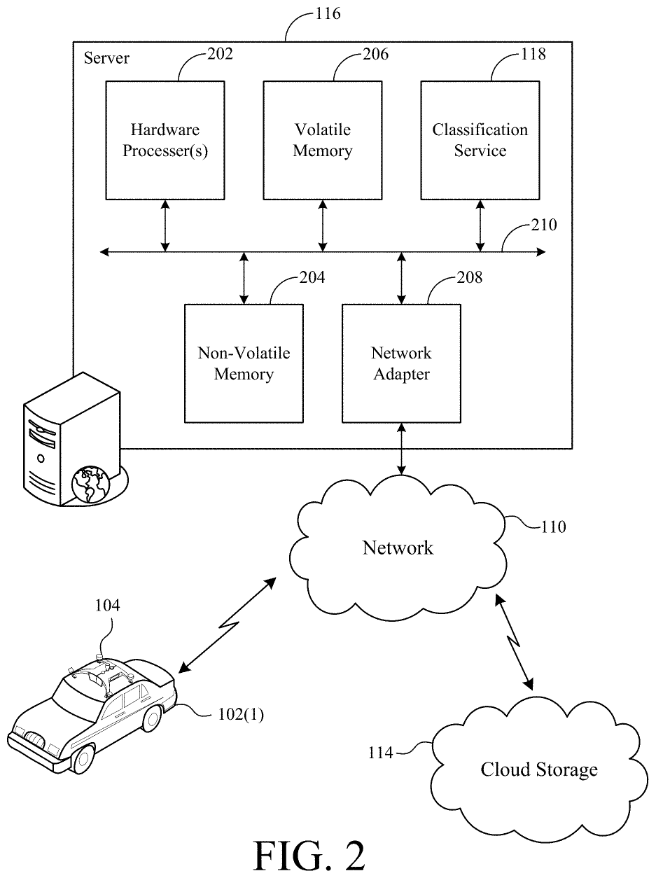

FIG. 2 is a block diagram showing an example one of servers 116 in greater detail. Server 116 includes at least one hardware processor 202, non-volatile memory 204, working memory 206, a network adapter 208, and classification service 118, all interconnected and communicating via a system bus 210. Hardware processor 202 imparts functionality to server 116 by executing code stored in any or all of non-volatile memory 204, working memory 206, and classification service 118. Hardware processor 202 is electrically coupled to execute a set of native instructions configured to cause hardware processor 202 to perform a corresponding set of operations when executed. In the example embodiment, the native instructions are embodied in machine code that can be read directly by hardware processor 202. Software and/or firmware utilized by server 116 include(s) various subsets of the native instructions configured to perform specific tasks related to the functionality of server 116. Developers of the software and firmware write code in a human-readable format, which is translated into a machine-readable format (e.g., machine code) by a suitable compiler.

Non-volatile memory 204 stores long term data and code including, but not limited to, software, files, databases, applications, etc. Non-volatile memory 204 can include several different storage devices and types, including, but not limited to, hard disk drives, solid state drives, read-only memory (ROM), etc. distributed across data center 112. Hardware processor 202 transfers code from non-volatile memory 204 into working memory 206 and executes the code to impart functionality to various components of server 116. For example, working memory 206 stores code, such as software modules, that when executed provides the described functionality of server 116. Working memory 206 can include several different storage devices and types, including, but not limited to, random-access memory (RAM), non-volatile RAM, flash memory, etc. Network adapter 208 provides server 116 with access (either directly or via a local network) to network 110. Network adapter 208 allows server 116 to communicate with vehicles 102, sensor units 104, and cloud storage 114, among others.

Classification service 118 includes software, hardware, and/or firmware configured for generating, training, and/or running machine learning networks for classifying objects captured in image data. Service 118 utilizes processing power, data, storage, etc. from hardware processor 202, non-volatile memory 204, working memory 206, and network adapter 208 to facilitate the functionality of scenario extraction service 118. For example, service 118 may access images stored in non-volatile memory 204 in order to train a classification network from the data. Service 118 may then store data corresponding to the trained network back in non-volatile memory 204 in a separate format, separate location, separate directory, etc. The details of classification service 118 will be discussed in greater detail below.

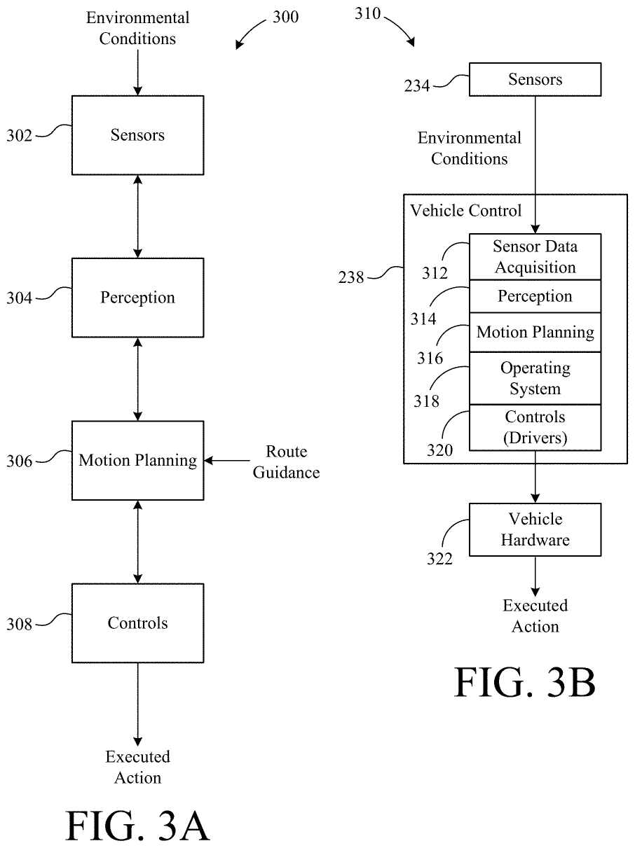

FIG. 3A is a flow chart summarizing an example method 300 of determining what commands to provide to an autonomous vehicle during operation. In a first step 302, sensors capture data representative of the environment of the vehicle. Then, in a second step 304, the sensor data is analyzed to form perceptions corresponding to the environmental conditions. Next, in a third step 306, the environmental perceptions (in conjunction with route guidance) are used to plan desirable motion. Then, in a fourth step 308, the planned motion(s) is/are used to generate control signals, which result in the desired motion.

FIG. 3B is a block diagram showing an example autonomous driving (AD) stack 310, which is utilized by autonomous vehicle 102 to determine what commands to provide to the controls of the vehicle (e.g., implementing method 300). Primarily, AD stack 310 is responsible for dynamic collision and obstacle avoidance. AD stack 310 is at least partially instantiated within vehicle computer 224 (particularly vehicle control module 238) and utilizes information that may or may not originate elsewhere. AD stack 310 receives input from sensors 234 and includes a sensor data acquisition layer 312, a perception layer 314, motion planning layer 316, an optional operating system layer 318, and a control/driver layer 320. AD stack 310 receives input from sensors 234 and provides control signals to vehicle hardware 322.

Sensors 234 gather information about the environment surrounding vehicle 102 and/or the dynamics of vehicle 102 and provide that information in the form of data to a sensor data acquisition layer 312. Sensors 234 can include, but are not limited to, cameras, LIDAR detectors, accelerometers, GPS modules, and any other suitable sensor including those yet to be invented. Perception layer 314 analyzes the sensor data to make determinations about what is happening on and in the vicinity of vehicle 102 (i.e. the “state” of vehicle 102), including localization of vehicle 102. For example, perception layer 314 can utilize data from LIDAR detectors, cameras, etc. to determine that there are people, other vehicles, sign posts, etc. in the area surrounding the vehicle and that the vehicle is in a particular location. Machine learning frameworks developed by classification service 118 are utilized as part of perception layer 314 in order to identify and classify objects in the vicinity of vehicle 102. It should be noted that there isn't necessarily a clear division between the functions of sensor data acquisition layer 312 and perception layer 314. For example, LIDAR detectors of sensors 302 can record LIDAR data and provide the raw data directly to perception module 304, which performs processing on the data to determine that portions of the LIDAR data represent nearby objects. Alternatively, the LIDAR sensor itself could perform some portion of the processing in order to lessen the burden on perception module 304.

Perception layer 314 provides information regarding the state of vehicle 102 to motion planning layer 316, which utilizes the state information along with received route guidance to generate a plan for safely maneuvering vehicle 102 along a route. Motion planning layer 316 utilizes the state information to safely plan maneuvers consistent with the route guidance. For example, if vehicle 102 is approaching an intersection at which it should turn, motion planning layer 316 may determine from the state information that vehicle 102 needs to decelerate, change lanes, and wait for a pedestrian to cross the street before completing the turn.

In the example, the received route guidance can include directions along a predetermined route, instructions to stay within a predefined distance of a particular location, instructions to stay within a predefined region, or any other suitable information to inform the maneuvering of vehicle 102. The route guidance may be received from data center 112 over a wireless data connection, input directly into the computer of vehicle 102 by a passenger, generated by the vehicle computer from predefined settings/instructions, or obtained through any other suitable process.

Motion planning layer 316 provides the motion plan, optionally through an operating system layer 318, to control/drivers layer 320, which converts the motion plan into a set of control instructions that are provided to the vehicle hardware 322 to execute the motion plan. In the above example, control layer 320 will generate instructions to the braking system of vehicle 102 to cause the deceleration, to the steering system to cause the lane change and turn, and to the throttle to cause acceleration out of the turn. The control instructions are generated based on models (e.g. depth perception model 250) that map the possible control inputs to the vehicle's systems onto the resulting dynamics. Again, in the above example, control module 308 utilizes depth perception model 250 to determine the amount of steering required to safely move vehicle 102 between lanes, around a turn, etc. Control layer 320 must also determine how inputs to one system will require changes to inputs for other systems. For example, when accelerating around a turn, the amount of steering required will be affected by the amount of acceleration applied.

Although AD stack 310 is described herein as a linear process, in which each step of the process is completed sequentially, in practice the modules of AD stack 310 are interconnected and continuously operating. For example, sensors 234 are always receiving, and sensor data acquisition layer is always processing, new information as the environment changes. Perception layer 314 is always utilizing the new information to detect object movements, new objects, new/changing road conditions, etc. The perceived changes are utilized by motion planning layer 316, optionally along with data received directly from sensors 234 and/or sensor data acquisition layer 312, to continually update the planned movement of vehicle 102. Control layer 320 constantly evaluates the planned movements and makes changes to the control instructions provided to the various systems of vehicle 102 according to the changes to the motion plan.

As an illustrative example, AD stack 310 must immediately respond to potentially dangerous circumstances, such as a person entering the roadway ahead of vehicle 102. In such a circumstance, sensors 234 would sense input from an object in the peripheral area of vehicle 102 and provide the data to sensor data acquisition layer 312. In response, perception layer 314 could determine that the object is a person traveling from the peripheral area of vehicle 102 toward the area immediately in front of vehicle 102. Motion planning layer 316 would then determine that vehicle 102 must stop in order to avoid a collision with the person. Finally, control layer 320 determines that aggressive braking is required to stop and provides control instructions to the braking system to execute the required braking. All of this must happen in relatively short periods of time in order to enable AD stack 310 to override previously planned actions in response to emergency conditions.

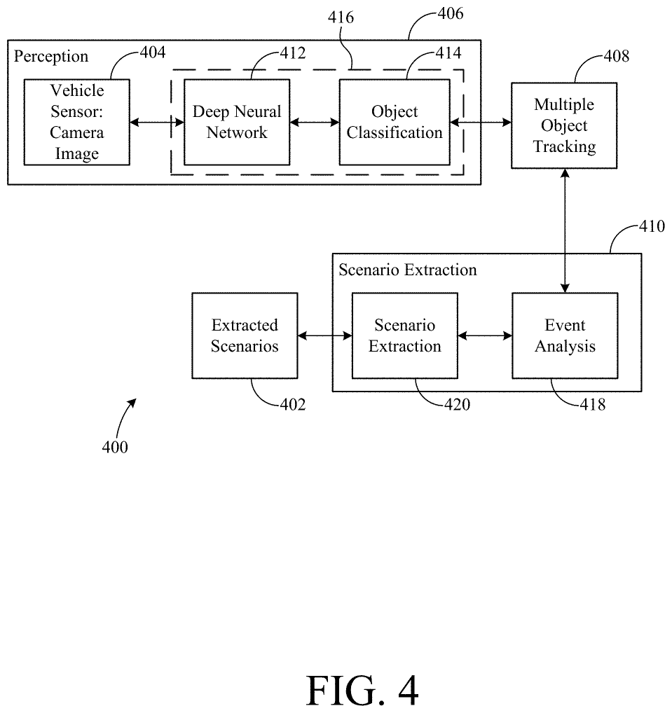

FIG. 4 is a block diagram illustrating a method 400 for utilizing the trained machine learning framework (e.g., the classification model) for extracting driving scenarios 402 from a camera image 404 captured by a vehicle camera. It should be noted that the present application allows for the use of images captured by autonomous vehicles, non-autonomous vehicles, and even vehicles simply outfitted with a dash camera. In the example embodiment, camera image 404 is sourced from a database of video data captured by autonomous vehicles 102.

A perception stage 406 generates object classifications from camera image 404 and provides the classifications to multi-object tracking stage 408. Multi-object tracking stage 408 tracks the movement of multiple objects in a scene over a particular time frame.

Multi-object tracking and classification data is provided to a scenario extraction stage 410, by multi-object tracking stage 408. Scenario extraction stage 410 utilizes the object tracking and classification information for event analysis and scenario extraction. In other words, method 400 utilizes input camera image(s) 404 to make determinations about what happened around a vehicle during a particular time interval corresponding to image(s) 404.

Perception stage 406 includes a deep neural network 412, which provides object classifications 414 corresponding to image(s) 404. Deep neural network 412 and depth prediction 414 comprise a machine learning framework 416. Deep neural network 412 receives camera image(s) 404 and passes the image data through an autoencoder. The encoded image data is then utilized to classify objects in the image, including those that have not been previously seen by network 412.

Scenario extraction stage 410 includes an event analysis module 418 and a scenario extraction module 420. Modules 418 and 420 utilize the multi-object tracking data to identify scenarios depicted by camera image(s) 404. The output of modules 418 and 420 is the extracted scenarios 402. Examples of extracted scenarios 402 include a vehicle changing lanes in front of the subject vehicle, a pedestrian crossing the road in front of the subject vehicle, a vehicle turning in front of the subject vehicle, etc. Extracted scenarios 402 are utilized for a number of purposes including, but not limited to, training autonomous vehicle piloting software, informing actuarial decisions, etc.

A significant advantage of the present invention is the ability for the object classification network to query large data without the need for human oversight to deal with previously unseen object classes. The system can identify frames of video data that contain vehicle-like instances, animals, etc., including those that it was not trained to identify. The queried data can then be utilized for active learning, data querying, metadata tagging applications, and the like.

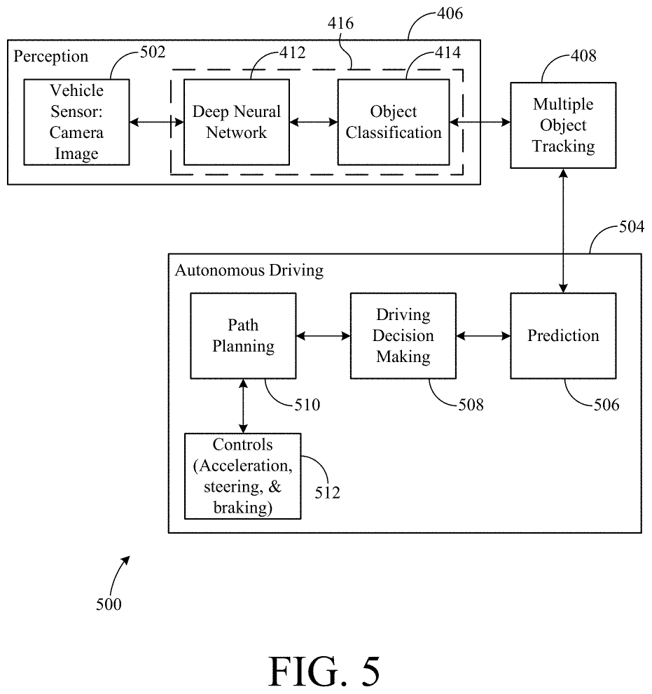

FIG. 5 is a block diagram illustrating a method 500 for utilizing the trained machine learning framework for piloting an autonomous vehicle utilizing a camera image 502 captured by the autonomous vehicle in real-time.

Method 500 utilizes perception stage 406 and multi-object tracking stage 408 of method 600, as well as an autonomous driving stage 504. Stages 406 and 408 receive image 502 and generate multi-object tracking data in the same manner as in method 400. Autonomous driving stage 504 receives the multi-object tracking data and utilizes it to inform the controls of the autonomous vehicle that provided camera image 502.

Autonomous driving stage 504 includes a prediction module 506, a driving decision making module 508, a path planning module 510 and a controls module 512. Prediction module 506 utilizes the multi-object tracking data to predict the future positions and/or velocities of objects in the vicinity of the autonomous vehicle. For example, prediction module 506 may determine that a pedestrian is likely to walk in front of the autonomous vehicle based on the multi-object tracking data. The resultant prediction is utilized by driving decision making module 508, along with other information (e.g., the position and velocity of the autonomous vehicle), to make a decision regarding the appropriate action of the autonomous vehicle. In the example embodiment, the decision made at driving decision making module 508 may be to drive around the pedestrian, if the autonomous vehicle is not able to stop, for example. The decision is utilized by path planning module 510 to determine the appropriate path (e.g. future position and velocity) for the autonomous vehicle to take (e.g. from a current lane and into an adjacent lane). Control module 512 utilizes the determined path to inform the controls of the autonomous vehicle, including the acceleration, steering, and braking of the autonomous vehicle. In the example embodiment, the autonomous vehicle may steer into the adjacent lane while maintaining consistent speed.

The present invention has several advantages, generally, for computer vision and, more particularly, for computer vision in autonomous vehicles. It is important to for an autonomous vehicle's computer vision service to identify at least a superclass related to an object in view. For example, if a child enters the roadway in front of the vehicle, it is important that the vehicle classifies the child as a “person” and not as an “animal”. However, prior computer vision services will not be able to identify a small child as a person unless explicitly trained to do so. The computer vision service of the example embodiment can identify the child as a person, even if trained only to identify adults, based on common features between children and adults (e.g., hairless skin, four limbs, clothing, etc.).

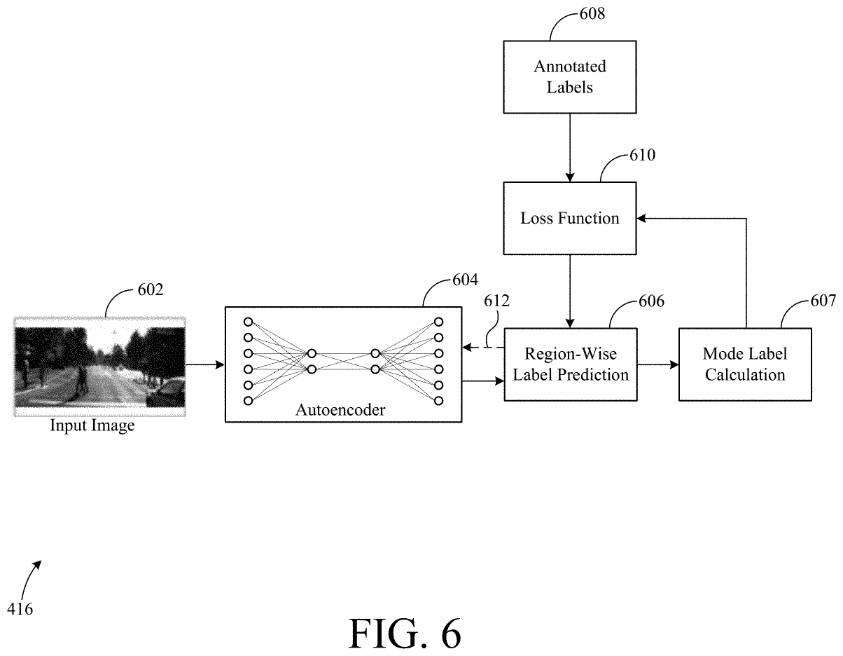

FIG. 6 is a block diagram illustrating a method for training machine learning framework 416. First an input image 602 is provided to an autoencoder 604. Autoencoder 604 is a neural network that attempts to recreate an input image from a compressed encoding of the input image, thereby identifying correlations between features of the input image. In other words, autoencoder 604 learns a data structure corresponding to the input image, where the data structure does not include redundancies present within the corresponding input image. The identified correlations should be representative of features of the input image, which can then be used to identify objects with similar features that belong to the same superclass. For example, given two inputs, one being a car and another being a truck, autoencoder 604 will identify features in the two images that may be similar (e.g., wheels, mirrors, windshield, etc.) or dissimilar (e.g. truck bed, car trunk, front grill, etc.). By decoding the identified features to recreate the input image, autoencoder 604 can identify which features correspond to which portions of the input image.

The output of autoencoder 604 is provided to a region-wise label prediction 606 which includes one or more additional layers of the neural network. Region-wise label prediction 606 predicts which regions of the input image correspond to which object categories, where the regions can be individual pixels, squares of pixels, etc. As an example, an image of a car may have regions that are similar to other vehicles (e.g., truck-like, van-like, bus-like, etc.). Therefore, region-wise label prediction 606 may include regions that are identified as portions of a car, a truck, a van, a bus, etc. Mode label calculation 607 identifies the object that is predicted in the majority of regions of the input image, and network 416 classifies the input image as belonging to the corresponding object class.

For training, mode label calculation 607 and annotated labels 608 are combined to generate a novel loss function 610. The loss function 610 identifies correct/incorrect classifications by region-wise label prediction 606 and alters region-wise label prediction 606 accordingly. In the example embodiment, region-wise label prediction 606 utilizes a clustering algorithm to identify similar features across classes and group these features together into “bins”. When a new image is encoded, region-wise label prediction 606 identifies the “bin” into which each segment of the image is embedded. Based on all of the results of this binning procedure, a classification is calculated, which may or may not reflect the actual superclass of the object in the new image. Loss function 610 is utilized to alter the binning procedure when the classification is incorrect, but not when the classification is correct, by altering the weights and biases of the nodes comprising region-wise label prediction 606. The result is that the system learns to correctly identify the features that correspond to the various object classes. As an alternative, loss function 610 can be backpropagated through autoencoder 604 (as shown by dashed arrow 612) as well as region-wise label prediction 606 to “teach” the system to more accurately predict object classes, but also to predict image regions belonging to different object classes from the same superclass.

As an example of the above methods, if an input image is a car, and the network correctly identifies the input image as a car while simultaneously identifying certain regions of the image as being truck-like, then the network will be rewarded, because the car and truck belong to the same superclass, namely vehicles. However, the network is punished for incorrectly identifying the object even when in the same superclass, or, in an alternative embodiment, for identifying regions of the image as belonging to an object class outside of the superclass, even when the superclass prediction itself is correct. Thus, the network can be taught to identify unseen objects as belonging to a superclass, by identifying the seen objects that share similar features.

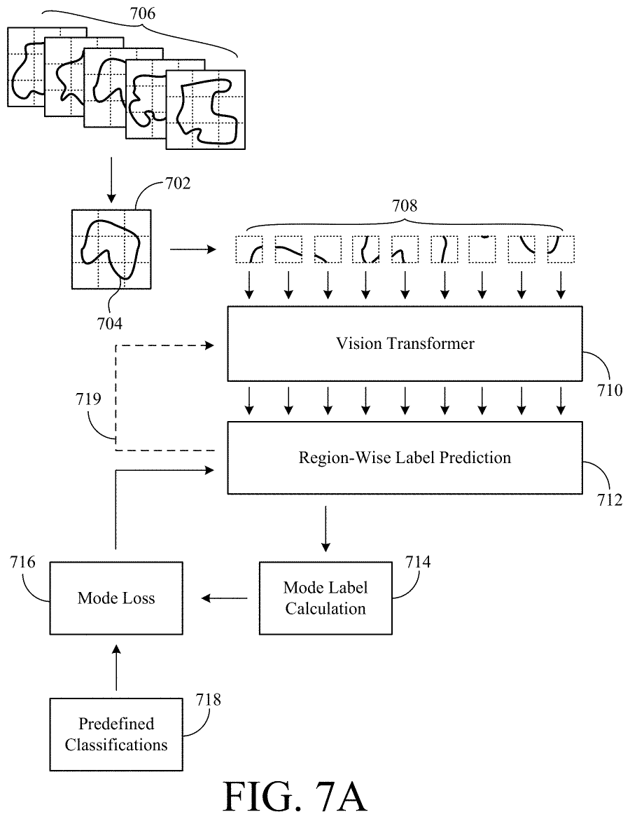

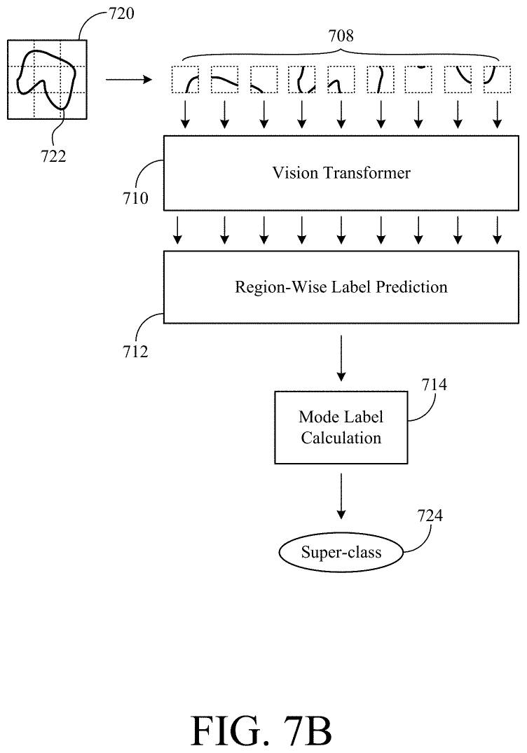

FIG. 7A is a data flow diagram showing a more detailed example method for training a neural network to classify objects captured in images. The example method utilizes a novel example loss function that does not directly penalize the network for misclassification, but instead forces the network to learn attributes that are common among multiple object classes while learning to classify objects.

An image 702 including an object 704 is selected from a dataset of images 706 and is segmented into a plurality of image segments 708. In an example embodiment, image 702 is a 224×224 pixel, 3-channel colored (e.g. RGB) image. Image segments 708 are 16×16 pixel, 3-channel colored patches from localized, non-overlapping regions of image 702. Therefore, image 702, in the example embodiment, is divided into 196 distinct image segments 708. (FIG. 7A is simplified for illustrative purposes).

In alternate embodiments, the images may be larger or smaller as needed to accommodate differing network architectures. The images could alternatively be black and white or encoded using an alternative color encoding. Similarly, image segments can be larger or smaller, be black and white, be generated from overlapping image regions, etc. Particularly, the image segments can be 4×4, 2×2, or even single pixels. Another alternative example method can utilize video. Instead of utilizing a single frame, the mode loss can be computed across multiple frames at test time, which allows for spatiotemporal object detection.

Each of image segments 708 is provided to a vision transformer 710, which encodes the image segments into a feature space, where, as a result of training, image segments 708 (from the entire training dataset 706) that are visually similar will be grouped together, while visually dissimilar ones of segments 708 are separated. The result is a group of clusters in the feature space, which are identified using K-means clustering. It should be noted that the number of clusters does not necessarily correspond to the number of known classes; rather it may correspond to a number of distinct image features identified in the training dataset. The network is trained to classify each segment based on the distance between the embedded features of the input segment and the centers of clusters that correspond to features of a particular class. After training, vision transformer 710 will embed input segments into the feature space and associate the embedded image features with the nearest clusters in the feature space.

In the example embodiment, vision transformer 710 is the ViT Dino architecture described in “Emerging Properties in Self-Supervised Vision Transformers” published in Proceedings of the IEEE/CVF International Conference on Computer Vision, pages 9650-9660, 2021 by Caron et al., which is incorporated by reference herein in its entirety. However, an advantage of the present method is that any object detection network can employ the novel loss function (as a standalone loss function or supplementary to another loss function) to detect not only objects from known classes, but also identify objects from unseen classes, in a single frame or across multiple frames. In other words, the example method is network-agnostic. It is important to note that some networks are capable of encoding information from surrounding image segments into each embedded image segment, which allows the image segments to be any size, including single pixels, while still containing information indicative of image features in the surrounding areas of the image.

A novel loss function of the example embodiment utilizes a “Mode Loss” calculation, which is split into two stages: a pixel-wise or region-wise label prediction 712, and a mode label calculation 714. Region-wise label prediction 712 is at least one layer of additional nodes on top of vision transformer 710 that predicts a label for each of segments 708. In the example embodiment, the prediction follows a modified one-hot encoding technique. In other words, for an image of size (W, H, 3), an example output tensor will be of size (M, N, K) where K is equal to the number of object classes, W is equal to the width of the image, H is equal to the height of the image, M is equal to the number of segments in a row, and N is equal to the number of segments in a column. In the case where a segment includes only a single pixel, M=W and N=H. By forcing the network to predict pixel-wise or patch-wise labels instead of a single label to classify the image, it can learn to determine which regions are visually similar to which objects. For example, given an image of a car, the wheel regions will have labels corresponding to “cars”, “trucks”, “busses”, etc. as common predictions (with non-zero probabilities), but will not contain labels corresponding to “dogs”, “cats”, or “humans”, etc. (these labels will have zero or approximately zero probabilities). This representation defines each object as some combination of similar objects. The example classification method provides an important advantage in that it provides an object detection network that learns to predict object labels as well as attribute-level labels, without any additional need for annotation.

Mode label calculation 714 picks the label of maximum probability for each of image segments 708 (i.e. identifies the likelihood of each label associated with the closest cluster center to the embedded image segment in the trained feature space). The output is a (M, N, 1) tensor. This tensor will have all “most confident” object labels at each point. Mode label calculation 714 then calculates the mode of the whole (M×N) matrix, which results in the predicted label for object 704 in image 702. In other words, if the majority of image segments 708 correspond to a particular object class, the example method outputs that particular object class as the label for object 704. This is the outcome during the example training method, where only the images including objects from known classes are provided to the network. The classification provided by the system when encountering unknown classes at test time will be described below with reference to FIG. 7B. In alternative embodiments, the system can be trained on unknown classes by considering the classifications belonging to the same superclass as correct.

A mode loss 716 is utilized to provide feedback to region-wise label prediction 712. Mode loss 716 compares the output of mode label calculation 714 to a predefined classification 718 for each of images 702. Mode loss 716 considers the classification correct, as long as most of segments 708 are classified correctly and will not penalize the network for predicting wrong labels in the rest of segments 716. For example, if an image (containing a car) has 32×32 pixels (1024 total), and most pixels (e.g. 425 out of 1024) predict “car”, but some (e.g. 350 out of 1024) predict “truck”, then the prediction is considered valid and the network is rewarded for it. The example method does not overly penalize bad predictions while encouraging the network to look for similar regions across object categories during training.

In an alternative example, the system may consider individual segment predictions to be invalid if they fall outside of the superclass of the main object classification. In other words, for an image of a car, all segments classified under the “vehicle” superclass (e.g., “car”, “truck”, “van”, etc.) are considered correct, while any segments labeled outside of the superclass (e.g., “dog”, “cat”, “bird”, etc.) are considered incorrect. In the alternative example, the incorrect segments would then be utilized to alter the network based on the loss function.

In the example embodiment, mode loss 716 is utilized to alter the network layers of region-wise label prediction 712 via a backpropagation method. In the example embodiment this method can utilize either of the L1 or L2 loss functions, which are used to minimize the sum of all the absolute differences between the predicted values and the ground truth values or to minimize the sum of the squared differences between the predicted values and the ground truth values, respectively. The example backpropagation method could use, as an example, a gradient descent algorithm to alter the network according to the loss function. In alternative embodiments, other loss functions/algorithms can be utilized, including those that have yet to be invented. As another example alternative, the backpropagation of the loss function can continue through region-wise label prediction 712 to vision transformer 710 (shown as dashed line 719) or, as yet another alternative, be directed through vision transformer 710 only.

The example loss function is an advantageous aspect of the example embodiment, because it can be used with any object classification, object detection (single or multi-stage), or semantic segmentation network. More generally, the entire system is advantageous for a number of reasons. For one, it is lightweight and can be used for real-time rare or unknown object detection. It can also be utilized for data curation or to query large amounts of raw data for patterns. As a particular example, a vehicle classifier trained according to the example method can identify all frames in a long sequence of video data that contain vehicle-like objects. A vanilla object classifier/detector cannot do this effectively because it is not rewarded for detecting unknown/rare objects/attributes. The example method also removes the need for manual data curation.

FIG. 7B is a data flow diagram showing an example method for utilizing an object classification network trained utilizing mode loss 716. A test image 720 including a test object 722 is segmented into image segments 708 and provided to vision transformer 710, which provides the region-wise label prediction 712. Region-wise label prediction 712 is utilized to perform mode label calculation 714, which provides an output super-class 724.

Mode Label calculation 714 labels object 722 as a combination of a number of similar objects. In other words, mode label calculation 714 identifies a super-class that includes most, if not all, of the object classes that are most likely to correspond to a segment 708 of image 720. This enables the example network to identify any new or rare object (for which there is not enough training data) using the example method, as it reasons any unknown object as a combination of features from a number of known objects. For example, given an image containing a “forklift”, at test time the network can identify that image as a “vehicle”, because most regions are similar to other classes (e.g., truck, car, van, etc.) that belong to the vehicle superclass.

In the example, the system only categorizes the super-class corresponding to an input image, even if the image belongs to a known object class. In alternative embodiments, additional methods could be utilized to first determine whether the image corresponds to one of the known object classes. For example, the system could determine whether a threshold number of object segments all correspond to the same object class. If so, that object class could then constitute the predicted classification for the image.

In yet another example, the superclass hierarchy can be generated from semantic data. For example, by a model trained on a large corpus of textual information. In such a corpus, “car”, “truck”, “van”, etc. will frequently appear together alongside “vehicle”. These words should not appear frequently, or at least as frequently, alongside “animal”, “plant”, etc. Additionally, the model will be able to identify phrases such as, “a car is a vehicle”, “cars and trucks are both vehicles”, and “a truck is not an animal”. A semantic model can, therefore, identify that “car”, “truck”, and “van” are subclasses of the “vehicle” superclass. In other examples, the superclass hierarchy can be manually identified.

Although the system/method illustrated by FIGS. 7A and 7B has been described in some detail, the following is a mathematical description of a similar example process including explanation of all variables.

I∈D

An image I is included in a dataset of images D.

F∈ [symbol] ^{M}^{²}^{×N}

A subspace representation F of features extracted from image I is an M²×N tensor of real numbers, where M² is the patch size and N is the feature dimension (i.e., the dimensionality of the output vector that encodes the image features of each patch).

I∈ [symbol] ^{224×224×3}

Image I includes three channels and 224×224 pixels.

Pₘ∈ [symbol] ^{16×16×3}|m_{m=1 . . . M}_{²}

Image I is divided into M² patches Pₘ, where each patch has 3 channels and 16×16 pixels.

[symbol]

=(Iₖ, yₖ, zₖ)ₖ₌₁^{K}∈X,

[symbol]

[symbol]

=(Iᵤ, yᵤ, zᵤ)ᵤ₌₁^{U}∈X,

[symbol]

The dataset is split into known object classes [symbol] and unknown object classes [symbol] , where [symbol] ∩ [symbol] =∅ (i.e., the images with known object classes and the images with unknown object classes are non-overlapping subsets of the dataset D). I and y denote images and class labels, respectively, while z denotes the superclass labels. The superclass labels are obtained by creating a semantic 2-tier hierarchy of existing object classes, via, for example, an existing dataset. The system is trained to reason object instances from [symbol] at test time after training on instances from [symbol] . [symbol] is not utilized for training.

f^{i,m}∈ [symbol] ^{N}|_{f∈F}

A feature f^{i,m} corresponding to a given image i and patch m is an N-dimensional vector of real numbers, where i∈I and m∈M².

f^{i,m,l}∈ [symbol] ^{N}|_{f∈F}

Optionally, location information corresponding to the patch is embedded in the feature vector, where a 2-dimensional position encoding {sin(x), cos(y)} is computed with x and y denoting the position of the patch in two dimensions.

C^{k}∈ [symbol] ⁷⁶⁸|_{k∈K}

After training there are K clusters of patch-wise features and C cluster centers in the embedded feature space, where each cluster center is a 768-dimensional vector (i.e., a point in a 768-dimensional space). In the example embodiment, clustering of the image features is accomplished by K-means clustering, using the elbow method to determine the number and locations of the clusters.

$${S}_{k} = \frac{1}{{Q}^{k}} {\sum }_{n = 1}^{{Q}^{k}} 𝔾 ( {f}_{c} ) \qquad where \{ \begin{matrix}𝔾 ( {f}_{c} ) = 1 & if {P}_{m} ∈ G \\ 0 & otherwise\end{matrix}$$

A semantic confidence vector Sₖ is a normalized summation of the number of patches that correspond to a particular class in each cluster k. In other words, a cluster is made up of a plurality of feature-space representations of various patches, and the semantic confidence vector for a particular cluster indicates the number of patches from each class that correspond to the particular cluster. P∈ [symbol] ^{G} means that each patch is one-hot encoded with a class label, where G is the number of classes in the training set. S∈ [symbol] ^{G×K} is the semantic confidence vector corresponding to an entire image, where all clusters K correspond to a histogram of all class labels that correspond to a patch within the cluster. The normalization allows S to be utilized as a confidence vector.

Using the vision transformer f(x), features F^{t}∈ [symbol] ^{M}^{²}^{33 N} are extracted from a test image I^{t}∈ [symbol] containing an object from an unknown class. The distances between features and the cluster centers C are then computed as follows:

Dₖ^{m}=argminₖ∥f^{i,m,l}−C^{k}∥₂

where each extracted feature (or corresponding patch) is associated with the nearest cluster center and the semantic confidence vector corresponding to that cluster center. Then the final semantic vector predictions [symbol] are obtained as follows:

$${ℙ}_{{I}^{t}} = \frac{1}{{M}^{2}} {\sum }_{m = 0}^{{M}^{2}} S ( {D}_{k}^{m} )$$

where an average of every semantic confidence vector S associated with every patch of the image is calculated. The semantic prediction vector [symbol] essentially quantifies similarities between the unseen object class of the test instance and all the known classes, taking into account both appearance and 2-D positional information. The semantic prediction vector is then interpreted to identify the predicted superclass. For example, assuming a test image produces a semantic prediction vector {car: 0.2, truck: 0.3, bike: 0.05, . . . , bird: 0.0}, the subsequent superclass prediction could be {vehicles: 0.7, furniture: 0.1, animals: 0.05, birds: 0.0 . . . }, where “vehicle” is deemed the most likely superclass.

In an alternative embodiment, rather than utilizing K-means clustering to identify feature clusters, a Gaussian mixture model may be utilized instead. Objects are modeled as a set of interdependent distributions. The model can be represented as a probability density function (PDF), as follows:

$$p ( x ) = {\sum }_{j = 1}^{K} ( {π}_{j} N ( x : {μ}_{j} , {\sum }_{j} ) )$$

where K is the number of Gaussian kernels mixed, πⱼ denotes the weights of the Gaussian kernels (i.e. how big the Gaussian is), μⱼ denotes the mean matrix of the Gaussian kernels, and Σⱼ denotes the covariance matrix of the Gaussian kernels. Features are extracted from an image and used for computing the Gaussian mixture model with K mixtures. An expectation maximization algorithm is used to fir the mixture on the extracted features into K mixtures, where j∈J is the total number of observations (images). K is estimated by computing cluster analysis using the elbow method.

The distance between two mixture components is computed using the KL-divergence distance between them as follows:

$${D}_{K L} ( p ‖ {p}^{′} ) = {\int }_{{R}^{d}} p ( x ) log \frac{p ( x )}{{p}^{′} ( x )} d x$$

where p and p′ are PDFs of mixture components.

Given a query image I^{t} the image is fed to the model to extract feature F^{t}. Then, the KL-divergence distances between the query image feature F^{t} and mixture centers using the equation above. Then, the class-relative weights are computed as follows:

W^{t}=∥S_{c}(F^{t}, μₖ)∥, where k∈K

where K is the number of mixtures in the Gaussian mixture model and μₖ is the mean of the k^{th} mixture.

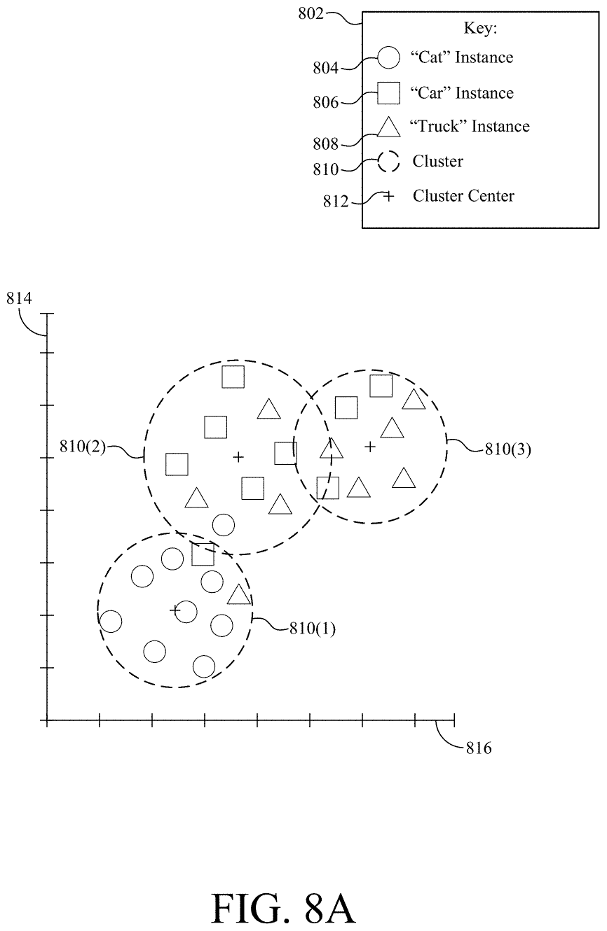

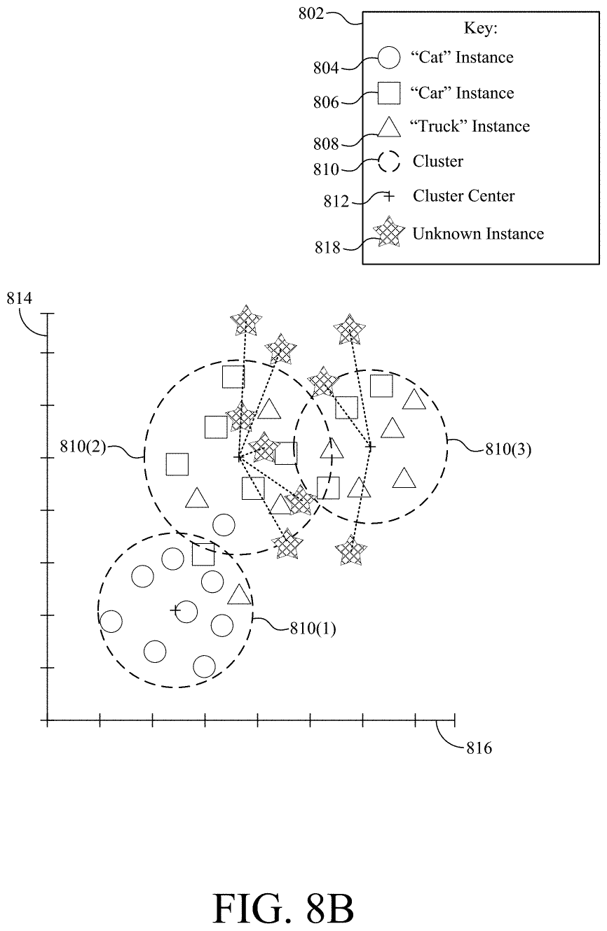

FIGS. 8A-8B illustrate example feature-space embeddings of image patches.

FIG. 8A is a graph illustrating a hypothetical feature-space embedding in two-dimensions, simplified for explanatory purposes. A key 802 shows that the feature space includes “cat” instances 804, “car” instances 806, “truck” instances 808, clusters 810, and cluster centers 812. Axes 814 and 816 show relative values along a first and a second dimension, respectively. FIG. 8A shows feature embeddings from three images, each including nine patches. The images are labeled “car”, “truck”, and “cat”, respectively. A clustering of the image space identified three separate clusters 810. A first cluster 810(1) includes 10 embedded patches: eight are cat instances 804, one is a car instance 806, and one is a truck instance 808. Therefore, the semantic confidence vector corresponding to cluster 810(1) is {cat: 0.8, car: 0.1, truck: 0.1}. A second cluster 810(2) includes nine embedded patches: one is a cat instance 804, five are car instances 806, and three are truck instances 808. Therefore, the semantic confidence vector corresponding to cluster 810(2) is {cat: 0.111, car: 0.555, truck: 0.333}. A third cluster 810(3) includes eight embedded patches: three are car instances 806 and five are truck instances 808. Therefore, the semantic confidence vector corresponding to cluster 810(3) is {cat: 0.0, car: 0.375, truck: 0.625}.

FIG. 8B is similar to FIG. 8A, except now an image containing an object belonging to an unknown instance 818 has been embedded in the feature space. In order to estimate a superclass for unknown instance 818, the nearest cluster to each of the embedded patches must be determined. In this case, six patches of unknown instance 818 are embedded closest to second cluster 810(2), while three patches are embedded closest to third cluster 810(3). Now, an average of the nine semantic confidence vectors corresponding to these clusters (six from second cluster 810(2) and three from third cluster 810(3)) is calculated as follows:

$$\frac{6 * \{ 0.111 , 0.555 , 0.333 \} + 3 * \{ 0. , 0.375 , 0.625 \}}{9} = \{ 0.074 , 0.495 , 0.4 \; 30 \}$$

where the result is the semantic prediction vector corresponding to the image of the unknown object. In this case, the object is roughly equally similar to a car or a truck, with very little similarity to a cat. Therefore, the unknown instance should be categorized within the “vehicle” superclass. It should be noted that this example is merely explanatory in nature. For practical use, an example model should include many more embedded patches, more clusters, more object classes, more dimensions in the feature space, etc.

The description of particular embodiments of the present invention is now complete. Many of the described features may be substituted, altered or omitted without departing from the scope of the invention. For example, alternate deep learning systems (e.g. ResNet), may be substituted for the vision transformer presented by way of example herein. This and other deviations from the particular embodiments shown will be apparent to those skilled in the art, particularly in view of the foregoing disclosure.

We Claim:

1. A method for categorizing an object captured in an image, said method comprising:
providing a neural network including a plurality of nodes organized into a plurality of layers, said neural network being configured to receive said image and provide a corresponding output;
defining a plurality of known object classes, each of said known object classes corresponding to a real-world object class and being defined by a class-specific subset of visual features identified by said neural network;
acquiring a first two-dimensional (2-D) image including a first object;
providing said first 2-D image to said neural network;
utilizing said neural network to identify a particular subset of said visual features corresponding to said first object in said first 2-D image;
identifying, based on said particular subset of said visual features, a first known object class most likely to include said first object; and
identifying, based on said particular subset of said visual features, a second known object class that is next likeliest to include said first object.

2. The method of claim 1, further comprising:
determining, based on said first known object class and said second known object class, a superclass most likely to include said first object; and wherein
said superclass includes said first known object class and said second known object class.

3. The method of claim 2, further comprising:
segmenting said first 2-D image into a plurality of image segments, each image segment including a portion of said first 2-D image; and wherein
said step of providing said first 2-D image to said neural network includes providing said image segments to said neural network; and
said step of identifying said first known object class includes identifying, for each image segment of said plurality of image segments, an individual one of said known object classes most likely to include a portion of said object contained in a corresponding image segment of said plurality of image segments.

4. The method of claim 3, wherein:
said step of identifying said first known object class includes, for each object class of said known object classes, identifying a number of said image segments of said plurality of image segments that contain a portion of said object most likely to be included in said each object class of said known object classes; and
said step of determining said superclass most likely to include said first object includes determining said superclass based at least in part on said number of said image segments that contain said portion of said object most likely to be included in said each object class of said known object classes.

5. The method of claim 3, wherein said step of segmenting said first 2-D image into said plurality of image segments includes segmenting said first 2-D image into said plurality of image segments, said plurality of image segments each including exactly one pixel of said first 2-D image.

6. The method of claim 3, further comprising receiving, as an output from said neural network, an output tensor including a plurality of feature vectors, each feature vector of said plurality of feature vectors being indicative of probabilities that a corresponding segment of said first 2-D image corresponds to each object class.

7. The method of claim 6, further comprising calculating an average of said feature vectors to generate a prediction vector indicative of said first known object class and said second known object class.

8. The method of claim 7, wherein said prediction vector has a number of dimensions equal to a number of said known object classes.

9. The method of claim 7, further comprising:
providing a plurality of test images each including a test object to said neural network;
segmenting each of said plurality of test images to create a plurality of test segments;
embedding each test segment of said plurality of test segments in a feature space to create embedded segments, said feature space being a vector space having a greater number of dimensions than said images;
associating each of said embedded segments with a corresponding object class according to a test object class associated with a corresponding one of said test images;
identifying clusters of said embedded segments in said feature space; and
generating a cluster vector corresponding to an identified cluster, said cluster vector being indicative of a subset of said known object classes associated with at least one of said embedded segments in said identified cluster.

10. The method of claim 9, wherein said step of utilizing said neural network to identify said particular subset of said visual features corresponding to said first object in said first 2-D image includes:
embedding said segments of said first 2-D image in said feature space to generate a plurality of embedded segments of said first 2-D image;
identifying a nearest cluster to each of said embedded segments of said first 2-D image;
associating each of said embedded segments with a corresponding one of said cluster vectors, said corresponding cluster vector being associated with said nearest cluster to said each of said embedded segments of said first 2-D image; and
said steps of identifying said first known object class and identifying said second known object class include identifying said first known object class and said second known object class based at least in part on said corresponding cluster vector associated with each of said embedded segments of said first 2-D image.

11. A system for categorizing an object captured in an image, comprising:
at least one hardware processor configured to execute code, said code including a native set of instructions for causing said hardware processor to perform a corresponding set of native operations when executed by said hardware processor; and
memory electrically connected to store data and said code, said data and said code including
a neural network including a plurality of nodes organized into a plurality of layers, said neural network being configured to receive said image and provide a corresponding output,
a first subset of said set of native instructions configured to define a plurality of known object classes, each of said known object classes corresponding to a real-world object class and being defined by a class-specific subset of visual features identified by said neural network,
a second subset of said set of native instructions configured to acquire a first two-dimensional (2-D) image including a first object and provide said first 2-D image to said neural network,
a third subset of said set of native instructions configured to utilize said neural network to identify a particular subset of said visual features corresponding to said first object in said first 2-D image, and
a fourth subset of said set of native instructions configured to
identify, based on said particular subset of said visual features, a first known object class most likely to include said first object and
identify, based on said particular subset of said visual features, a second known object class that is next likeliest to include said first object.

12. The system of claim 11, wherein:
said fourth subset of said set of native instructions is additionally configured to determine, based on said first known object class and said second known object class, a superclass most likely to include said first object; and
said superclass includes said first known object class and said second known object class.

13. The system of claim 12, wherein:
said second subset of said set of native instructions is additionally configured to segment said first 2-D image into a plurality of image segments, each image segment including a portion of said first 2-D image;
said second subset of said set of native instructions is configured to provide said image segments to said neural network; and
said fourth subset of said set of native instructions is additionally configured to identify, for each image segment of said plurality of image segments, an individual one of said known object classes most likely to include a portion of said object contained in a corresponding image segment of said plurality of image segments.

14. The system of claim 13, wherein said fourth subset of said set of native instructions is additionally configured to:
identify, for each object class of said known object classes, a number of said image segments of said plurality of image segments that contain a portion of said object most likely to be included in said each object class of said known object classes; and
determine said superclass based at least in part on said number of said image segments that contain said portion of said object most likely to be included in said each object class of said known object classes.

15. The system of claim 13, wherein said plurality of image segments each include exactly one pixel of said first 2-D image.

16. The system of claim 13, wherein said third subset of said set of native instructions is additionally configured to receive, as an output from said neural network, an output tensor including a plurality of feature vectors, each feature vector of said plurality of feature vectors being indicative of probabilities that a corresponding segment of said first 2-D image corresponds to each object class.

17. The system of claim 16, wherein said fourth subset of said set of native instructions is additionally configured to calculate an average of said feature vectors to generate a prediction vector indicative of said first known object class and said second known object class.

18. The system of claim 17, wherein said prediction vector has a number of dimensions equal to a number of said known object classes.

19. The system of claim 17, wherein:
said data and said code include a fifth subset of said set of native instructions configured to
provide a plurality of test images to said neural network, each of said test images including a test object and
segment each of said plurality of test images to create a plurality of test segments;
said neural network is additionally configured to embed each test segment of said plurality of test segments in a feature space to create embedded segments, said feature space being a vector space having a greater number of dimensions than said images; and
said data and said code include a sixth subset of said set of native instructions configured to
associate each of said embedded segments with a corresponding object class according to a test object class associated with a corresponding one of said test images,
identify clusters of said embedded segments in said feature space, and
generate a cluster vector corresponding to an identified cluster, said cluster vector being indicative of a subset of said known object classes associated with at least one of said embedded segments in said identified cluster.

20. The system of claim 19, wherein:
said neural network is configured to embed said segments of said first 2-D image in said feature space to generate a plurality of embedded segments of said first 2-D image;
said sixth subset of said set of native instructions is additionally configured to
identify a nearest cluster to each of said embedded segments of said first 2-D image and
associate each of said embedded segments with a corresponding one of said cluster vectors, said corresponding cluster vector being associated with said nearest cluster to said each of said embedded segments of said first 2-D image; and
said fourth subset of said set of native instructions is configured to identify said first known object class and said second known object class based at least in part on said corresponding cluster vector associated with each of said embedded segments of said first 2-D image.
